(19) United States
(12) Patent Application Publication
(10) Pub. No.: US 2014/0297628 A1
(43) Pub. Date: Oct. 2, 2014

(54) Text Information Processing Apparatus, Text Information Processing Method, and Computer Usable Medium Having Text Information Processing Program Embodied Therein

(71) Applicant: JVC KENWOOD Corporation, Kanagawa (JP)

(72) Inventors: Ryoko TSUJI, Ichikawa-shi (JP); Ichiro SHISHIDO, Zushi-shi (JP)

(73) Assignee: JVC KENWOOD Corporation, Kanagawa (JP)

(21) Appl. No.: 14/224,776

(22) Filed: Mar. 25, 2014

(30) Foreign Application Priority Data
Mar. 29, 2013 (JP) 2013-072314

(51) Int. Cl. G06F 17/30

(52) U.S. Cl. CPC G06F 17/3053
USPC 707/723

(57) ABSTRACT

A text information processing apparatus includes a retrieval part, a degree-of-similarity calculation part and a determination part. The retrieval part obtains a retrieval result set which includes one or plural pieces of item information and corresponds to a retrieval key extracted from text data, from item database. The degree-of-similarity calculation part calculates a score of the retrieval result set, based on one or more pieces of degree of similarity each between different pieces of item information in the plural pieces of item information. The determination part identifies item information corresponding to the text data from among the plural pieces of item information, based on the score.

### CROSS REFERENCE TO RELATED APPLICATION

This application claims benefit of priority under 35 U.S.C. §119 to Japanese Patent Application No. 2013-072314, filed on Mar. 29, 2013, the entire contents of which are incorporated by reference herein.

### BACKGROUND

The present invention relates to a technique for analyzing text data.

Recently, services such as Internet message board and Social Network Service (SNS) in which a user easily uploads a text such as word-of-mouth information to release the text, increase according to the spread of the Internet. Many companies pay attention to grasp of information such as word-of-mouth information on the Internet in view of their marketing strategies.

However, since texts on the Internet uploaded by respective users usually include omission of words or phrases and orthographic variants therein, there is a problem that it is difficult to retrieve a proper keyword quickly from the texts. As a technique for addressing the problem, there is a technique disclosed in Patent Literature 1 (Japanese Patent Application Laid-Open Publication No. 2011-3157), for example.

Patent Literature 1 discloses a technique for analyzing text data to identify an item which is a product or a service and summarizing word-of-mouth information of users for each item. However, accuracy in determining which item the text data to be analyzed corresponds to, is not always good. For example, in a case where a description object which is a subject described in text data, is associated with a field such as music, movie or the like, since the description object has various names and there is not a definite rule about a character string representing a name, there is a possibility that accuracy in identifying an item corresponding to a desired description object is not good. Due to this, there is a possibility that an item corresponding to a description object in text data is not identified or another item different from an item corresponding to a description object in text data is identified.

### SUMMARY

An object of the present invention is to provide a text information processing apparatus, a text information processing method, and a computer usable medium having text information processing program embodied therein that accurately identify information on a description object in text data.

According to one aspect of the present invention, there is provided a text information processing apparatus including: a retrieval part configured to obtain a retrieval result set which includes one or plural pieces of item information and corresponds to a retrieval key extracted from text data, from item database which stores item information therein; a degree-of-similarity calculation part configured to calculate a score of the retrieval result set, based on one or more pieces of degree of similarity each between different pieces of item information in the plural pieces of item information; and a determination part configured to identify item information corresponding to the text data from among the plural pieces of item information, based on the score.

According to one aspect of the present invention, there is provided a text information processing method including: obtaining a retrieval result set which includes one or plural pieces of item information and corresponds to a retrieval key extracted from text data, from item database which stores item information therein; calculating a score of the retrieval result set, based on one or more pieces of degree of similarity each between different pieces of item information in the plural pieces of item information; and identifying item information corresponding to the text data from among the plural pieces of item information, based on the score.

According to one aspect of the present invention, there is provided a non-transitory computer usable medium having text information processing program embodied therein, the text information processing program including: a first text information processing program code for causing a computer to obtain a retrieval result set which includes one or plural pieces of item information and corresponds to a retrieval key extracted from text data, from item database which stores item information therein; a second text information processing program code for causing the computer to calculate a score of the retrieval result set, based on one or more pieces of degree of similarity each between different pieces of item information in the plural pieces of item information; and a third text information processing program code for causing the computer to identify item information corresponding to the text data from among the plural pieces of item information, based on the score.

According to the present invention, the text information processing apparatus, the text information processing method, and the computer usable medium having text information processing program embodied therein can accurately identify information on a description object in text data.

### BRIEF DESCRIPTION OF THE DRAWINGS

FIG. 1 is a block diagram which illustrates a whole system configuration according to a first and a second embodiment of the present invention.

FIG. 2A is a diagram which illustrates an example of article text (text data).

FIG. 2B is a diagram which illustrates an example of an extracted keyword.

FIG. 3 is a flowchart which illustrates an operation of a text information processing apparatus according to the first embodiment of the present invention.

FIGS. 4A to 4C are diagrams each of which illustrates an example of a method for extracting a keyword from the article text.

FIG. 5 is a diagram which illustrates an example of data stored in a text data storage according to the first embodiment of the present invention.

FIG. 6 is a diagram which illustrates an example of data stored in an item data base according to the first embodiment of the present invention.

FIG. 7 is a diagram which illustrates an example of data stored in a keyword group storage according to the first embodiment of the present invention.

FIG. 8 is a diagram which illustrates an example of data stored in a score storage according to the first embodiment of the present invention.

FIG. 9 is a diagram which illustrates an example of data stored in an item calculation result storage according to the first embodiment of the present invention.

FIG. 10 is a diagram which illustrates an example of data stored in an item ranking information storage according to the first embodiment of the present invention.

FIG. 11 is a part of a flowchart which illustrates an operation of a text information processing apparatus according to the second embodiment of the present invention.

FIG. 12 is the remaining part of the flowchart which illustrates the operation of the text information processing apparatus according to the second embodiment of the present invention.

### DETAILED DESCRIPTION

A first and a second embodiment of the present invention will be described below with reference to drawings. It is noted that the same reference number is assigned to the same element in the drawings. In the following description, an item may be contents of sounds, music, images, web pages or the like, various goods, information on financial product, real estate or person, or the like. The item may be tangible or intangible and free or charge.

### First Embodiment

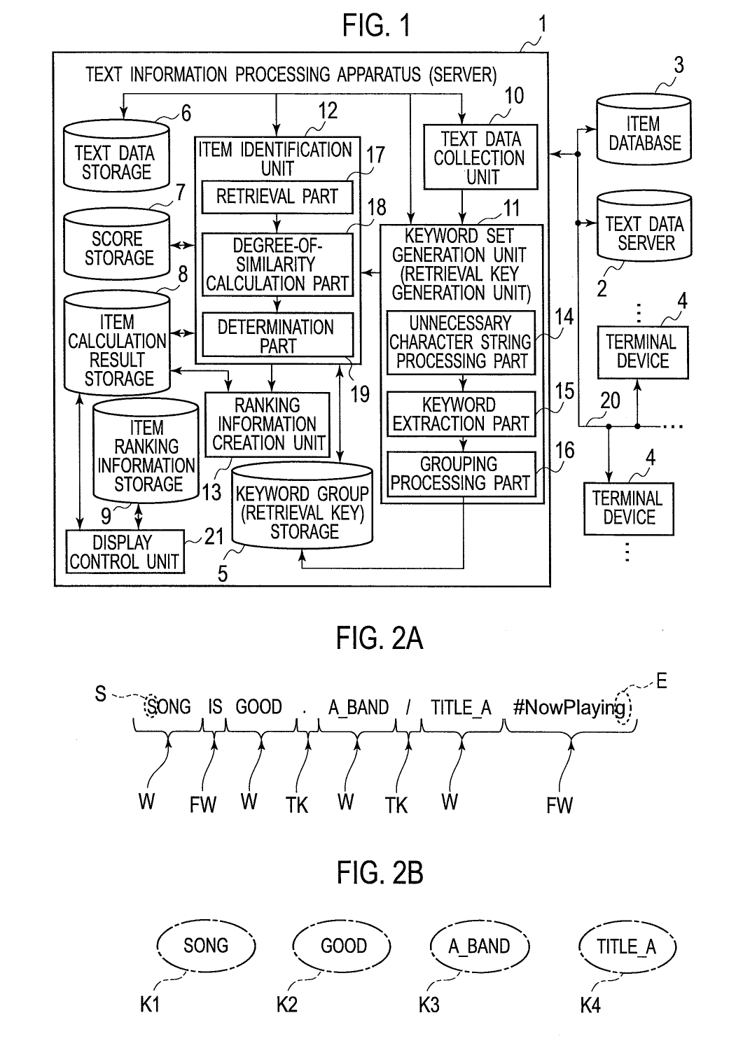

FIG. 1 is a block diagram which illustrates a whole system configuration including a text information processing apparatus 1 according to the present embodiment. This system includes the text information processing apparatus 1, a text data server (blog server) 2, an item database (item data server) 3, terminal devices 4 of users, and the like. Each element can communicate with another element via a network 20. The text information processing apparatus 1 is a server, for example. The text data server 2 stores text data therein. The item database 3 stores information on each item.

In the following description, blog data is cited as one example of text data to be processed in the text information processing apparatus 1. The blog data includes text data created by a user. For example, the blog data includes text data (blog article) which a user creates using a social network service. Twitter (registered trademark), Facebook (registered trademark), mixi (registered trademark) or the like is cited as the social network service, for example.

Although the text data server 2 and the item database 3 are shown as independent elements in FIG. 1, a part or all of these elements may be incorporated in the text information processing apparatus 1.

The text information processing apparatus 1 includes a text data collection unit 10, a keyword set generation unit 11, an item identification unit 12 and a ranking information creation unit 13. In the text information processing apparatus 1, although these units are shown as independent units in FIG. 1, they may be integrated into one unit. These units may be configured using a single CPU, DSP or the like, or a plurality of CPUs or DSPs or the like.

The text information processing apparatus 1 further includes a keyword group storage 5, a text data storage 6, a score storage 7, an item calculation result storage 8 and an item ranking information storage 9. In the text information processing apparatus 1, although these storages are shown as independent units in FIG. 1, they may be integrated into one unit. These storages may be configured using a single hard disk drive (HDD), flash memory or the like, or a plurality of hard disk drives (HDDs), flash memories or the like.

The text data collection unit 10 collects plural pieces of identification information such as an article text (text data) such as blog, a user identifier of a writer who creates the article text, and an update data when the article text is created, from the text data server 2 storing text data therein, and then stores them in the text data storage 6. It is noted that the user identifier is an identifier for identifying a user related to creation of text data, or a terminal device related to creation of text data. The text data storage 6 is not always required, and the text data server 2 may function as the text data storage 6.

The keyword set generation unit 11 includes an unnecessary character string processing part 14, a keyword extraction part 15 and a grouping processing part 16. The keyword set generation unit 11 extracts a keyword for identifying an item from the text data collected by the text data collection unit 10, and then generates a keyword group (retrieval key). Retrieval is carried out using the keyword group which will be described later in detail. The unnecessary character string processing part 14 generates text data in which unnecessary information that is not related to item information is excluded. The unnecessary information that is not related to item information is information such as document link information, meta tag or the like. Process in the unnecessary character string processing part 14 will be described later.

The keyword extraction part 15 extracts a keyword from the text data processed by the unnecessary character string processing part 14. The grouping processing part 16 groups one or more keywords extracted by the keyword extraction part 15, and then stores a keyword group which is a set of the grouped one or more keywords, in the keyword group storage 5. It is noted that even if the keyword group includes only one keyword, it is called a keyword group.

The item identification unit 12 includes a retrieval part 17, a degree-of-similarity calculation part 18 and a determination part 19. The item identification unit 12 retrieves item information from the item database 3, using the keyword group generated by the keyword set generation unit 11, and determines validity of a keyword with reference to plural pieces of degree of similarity regarding plural pieces of item information obtained based on the retrieval result.

The retrieval part 17 retrieves the item database 3 using the keyword group generated by the keyword set generation unit 11. If a retrieval result set composed of plural pieces of item information is obtained, the degree-of-similarity calculation part 18 calculates plural pieces of degree of similarity each between different pieces of item information in the plural pieces of item information. The degree-of-similarity calculation part 18 further calculates a score related to the retrieval result set for each keyword group using the plural pieces of degree of similarity each between different pieces of item information in the plural pieces of item information, based on a formula for calculation which will be described later, and then stores the score in the score storage 7.

The determination part 19 compares the score calculated by the degree-of-similarity calculation part 18 with a threshold θ and then determines a validity of the keyword group used in the retrieval of the item database 3. The determination part 19 identifies an item related to the article text (text data) using a retrieval result set corresponding to a valid keyword group. The determination part 19 associates the identified item (item identifier) with a blog identifier of a text data from which the valid keyword group is extracted, and then stores it in the item calculation result storage 8. If there is a plurality of valid keyword groups, the determination part 19 may identify an item using a retrieval result set corresponding to a valid keyword group which has the highest score in the plurality of valid keyword groups, or may identify an item using a plurality of retrieval result sets corresponding to the plurality of valid keyword groups.

The ranking information creation unit 13 carries out ranking based on the number of appearances of each item calculated using data in the item calculation result storage 8, and then stores it in the item ranking information storage 9. Even if the text information processing apparatus 1 does not include the ranking information creation unit 13, it is possible to precisely identify information which is a description object in text data. However, if the text information processing apparatus 1 includes the ranking information creation unit 13, it is possible to output an analysis result by the text information processing apparatus 1 in useful format.

The text information processing apparatus 1 may be configured using a general computer which includes a CPU (Central Processing Unit), a RAM (Random Access Memory), a ROM (Read Only Memory), an HDD (Hard Disk Drive), a network interface and the like. That is, a program may cause a computer to execute processing which will be described later, to function as the text information processing apparatus 1.

The text information processing apparatus 1 may be configured using a plurality of computers. For example, the text information processing apparatus 1 may execute distributed processing using a plurality of computers corresponding to a processing block in the text information processing apparatus 1, that is using a plurality of computers handling the same processing block, so as to execute load distribution. Also, distributed processing may be executed in a configuration where a computer handles a processing block which is a part of the text information processing apparatus 1, and another computer handles another processing block.

Concrete processing in the text information processing apparatus 1 will be described using FIGS. 2 to 9.

An example in which based on an article text (text data) on music, item information for representing the music is identified and based on the identified item information, ranking information is created, will be described below. It is noted that an item is not limited to music, and may be various contents, a product or a service.

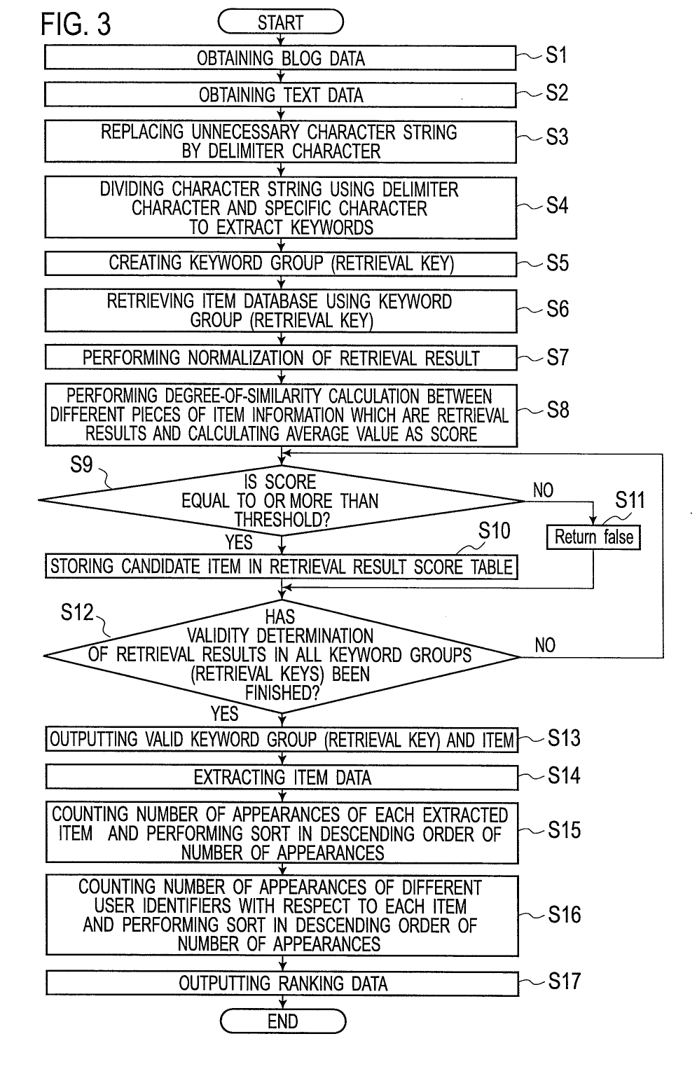

FIG. 3 shows a processing flow in the text information processing apparatus 1. In step S1, the text data collection unit 10 obtains text data from the text data server 2 and then stores the obtained text data in the text data storage 6. More specifically, the text data collection unit 10 sends a certain request command to the text data server 2 to receive (obtain) blog data including a user identifier, an article text (text data), an article creation update date and the like. The text data collection unit 10 stores the received data in a text data table in the text data storage 6.

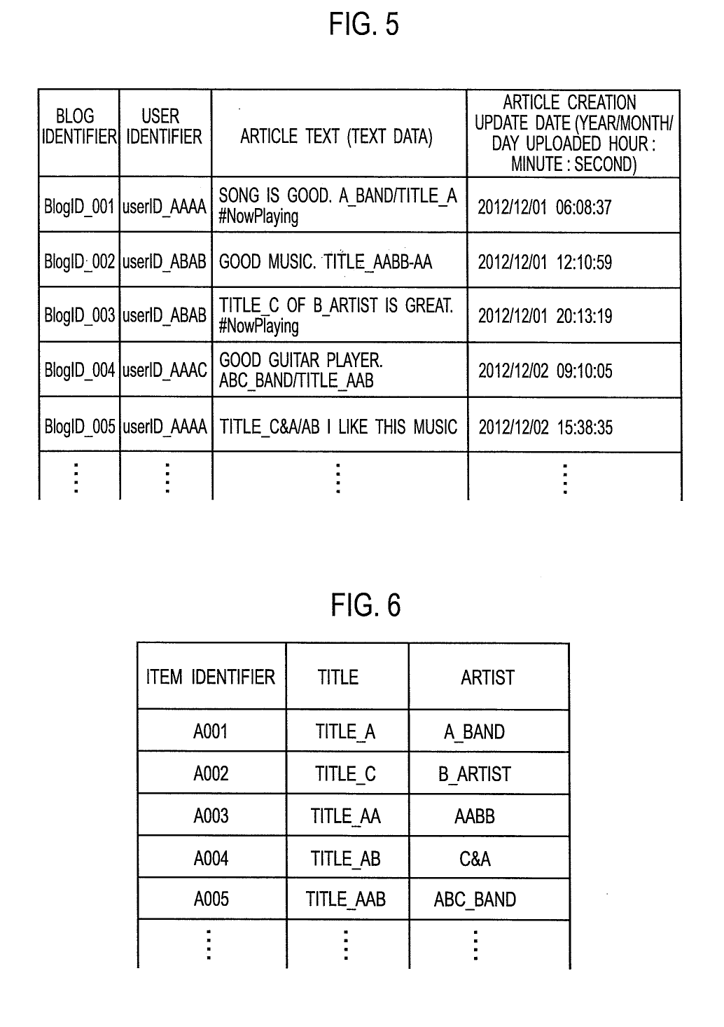

At this time, the text data collection unit 10 assigns one piece of identification information (blog identifier) to each article text. One example of storage format in the text data table is shown in FIG. 5. A blog identifier, a user identifier, an article text and an article creation update date (date when an article is uploaded) are associated with one another. For example, an blog identifier is assigned every time when a user sends text data to the text data server 2 in one upload.

Although a blog identifier in the present embodiment is represented by a character string “BlogID”, an underscore and a sequential number in this order, wherein the sequential number increases in order of article creation update date, it may be represented by a user ID and a sequential number or by an article obtaining date and a sequential number in this order. It is only required that each piece of blog data can be uniquely identified. If the text data server 2 has a blog identifier (or data corresponding to a blog identifier) and the text data collection unit 10 receives (obtains) the blog identifier (or data), the text data collection unit 10 may omit the process for assigning a blog identifier and use the received blog identifier.

Regarding the read of the blog data, the text data collection unit 10 may designate a range (period) of necessary article creation update date using a request command, and obtain data corresponding to it. The text data collection unit 10 may designate a necessary user identifier using a request command, and obtain article data of only the user. Also, the text data collection unit 10 may obtain blog data which includes only the specific character string pattern in an article text, using a request command which includes a retrieval style for character string.

### (Operation of Keyword Set Generation Unit 11)

Returning to FIG. 3, in steps S2 to S5, the keyword set generation unit 11 carries out keyword set generation processing. In step S2, the keyword set generation unit 11 reads (obtains) text data for each blog identifier from the text data table in the text data storage 6. In the subsequent processing, the processing is carried out with respect to each text data.

In step S3, the unnecessary character string processing part 14 replaces a character string (unnecessary character string FW) which is unhelpful to identify an item in characters from the beginning to the end of text data, by a certain delimiter character K. For example, a character (or combination of characters) “¥¥” which has a low possibility to appear in an article text is replaced by the delimiter character K. Although an unnecessary character string may be deleted without being replacing or be replaced by a blank character (e.g., space character, tab character or the like), it is preferable to replace the unnecessary character string by the delimiter character K because it is helpful to extract a character string for use in identification of an item. For the certain delimiter character K, it is noted that it is not necessary to use the same character at all times. The delimiter character K may be arbitrarily changed according to text data. For example, the delimiter character K may be changed according to a language type or a character type in text data.

With reference to FIGS. 2A and 5, the processing by the unnecessary character string processing part 14 in step S3, will described in detail.

FIG. 2A is a diagram which illustrates an example of article text (text data) for use in identification of item information. In the example of FIG. 2A, normal character strings W, specific characters TK and unnecessary character strings FW are included from the beginning S to the end E in the text data. It is noted that text data does not necessarily include a specific character TK and an unnecessary character string FW. Also, there is a case where text data includes plural specific characters TK and unnecessary character strings FW. The keyword extraction part 15 extracts a normal character string W other than a specific character TK and an unnecessary character string FW. The extraction method will be described later. It is noted that one character will be called a character string in the present embodiment. The normal character string W is a character string which has a possibility to be helpful to identify an item. For example, the normal character string W is a character string other than the specific character TK and the unnecessary character string FW.

FIG. 5 is a diagram which illustrates an example of data (text data table) stored in a text data storage 6. As shown in FIG. 5, an article text, a blog identifier assigned to the article text, a user identifier representing a user who uploads the article text, an article creation update date representing an update date when the article text is uploaded, are associated with one another and stored in the text data table. As shown in the article text of FIG. 5, there are various words and expression forms used in varied texts such as blogs created by users.

In general, a character string which is helpful to identify an item, and an unnecessary character string are mixed in text data. In the example of FIG. 5, “#NowPlaying” is a character string which idiomatically represents that it is an article related to playback of music or video contents. Since the character string “#NowPlaying” is used to an article related to any item, this character string is not helpful to identify an item and is recognized as an unnecessary character string FW.

For example, in a text in a service (Micro Blog Service) in which a relatively short article text such as Twitter is often uploaded, URL (Uniform Resource Locator) representing a link to another site is often included. Since there are many cases where an item name and the like are not included in a character string of URL, the character string of URL is not helpful to identify an item. Due to this, a URL character string having the beginning “http://” or the like is recognized as an unnecessary character string. Especially, since there are many cases where an item name and the like are not included in a character string of abbreviated URL, only the character string of abbreviated URL may be recognized as an unnecessary character string FW.

Further, since there are many cases where an item name and the like are not included in a mark such as meta tag (a character string between “<” and “>”) or musical note ( [symbol] ), the mark is recognized as an unnecessary character string FW. The mark may be any of one-byte and two-byte characters.

The unnecessary character string processing part 14 determines whether or not an unnecessary character string FW is included in text data, with reference to database which describes a list of unnecessary character strings FW, a condition of a character string to be recognized as an unnecessary character string FW, or the like. The unnecessary character string processing part 14 replaces the unnecessary character string FW by the certain delimiter character K.

Since the unnecessary character string processing part 14 replaces an unnecessary character string by not a blank character, but instead a certain character which has a low possibility that it is used in a blog article or the like, it is possible to accurately extract a keyword which is helpful to identify an item.

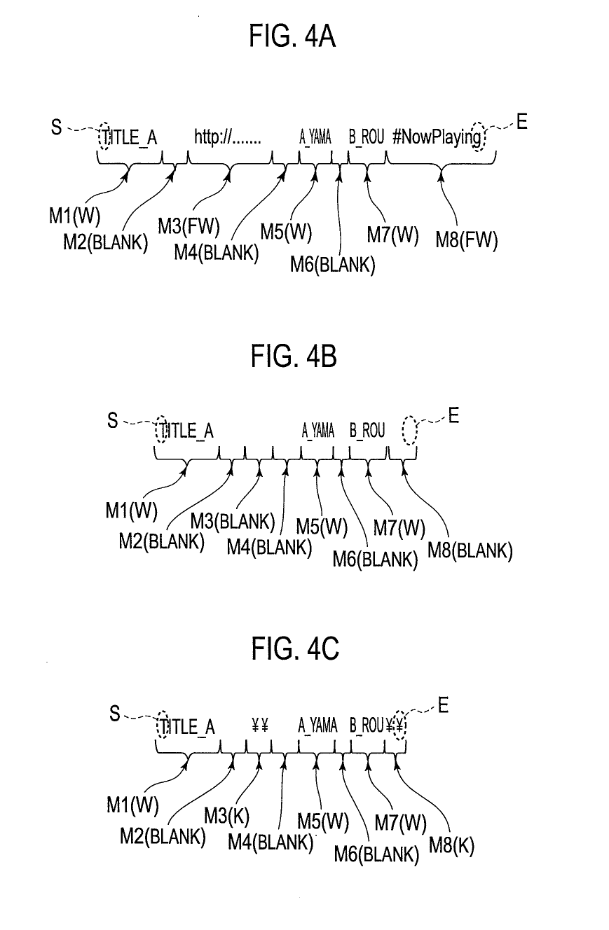

For example, in a case where there is an article text which has a pattern “M1: title, M2: blank, M3: URL, M4: blank, M5: artist (last name), M6: blank, M7: artist (first name) and M8: #NowPlaying” shown in FIG. 4A, if the unnecessary character string processing part 14 replaces M3: URL and M8: #NowPlaying which are unnecessary character strings FW, by blank characters as shown in FIG. 4B, it is difficult to determine whether or not character strings M5 and M7 are treaded as one keyword when there is a blank between the character strings M5 and M7 which are keywords helpful to identify an item.

Namely, it is advantageous to extract the character string M5: artist (last name) and the character string M7: artist (first name) as one keyword. In contrast, when the unnecessary character strings FW are replaced by blank characters, it is difficult to integrate character strings.

On the other hand, if the unnecessary character string processing part 14 replaces M3: URL and M8: #NowPlaying which are unnecessary character strings FW, by delimiter characters K (e.g., “¥¥” in FIG. 4C), the keyword extraction part 15 ignores blank and delimits text data using the delimiter characters K. Therefore, it is possible to integrate the character strings M5 and M7 and treat them as one keyword, which accurately identifies an item. Although an unnecessary character string FW is replaced by a delimiter character K (e.g., “¥¥”) independent of the number of characters in the unnecessary character string FW, each of characters constituting the unnecessary character string FW may be replaced by the delimiter character K (e.g., “¥¥”).

It is noted that it is possible to treat an exclusion character described in Patent Literature 1, punctuation mark or the like as unnecessary character string FW. The exclusion character described in Patent Literature 1 is Japanese character “ [symbol] (no)”, “ [symbol] (ga)”, “ [symbol] (i)” and “ [symbol] (ku)” or the like.

Next, a specific character TK will be described. In text data related to music being replaying which is an object in the present embodiment, there are not clear rules with respect to an order and a format in which a music name and an artist name are described. However, as shown in text data in FIGS. 2A and 5, there are many cases where a hyphen “-” or a slash “/” is used as a character for distinguishing between a text and an artist. In the present embodiment, this character is called a specific character TK. In text data, there is a case where the specific character TK appears or does not appear.

In a case of carrying out processing for replacing an unnecessary character string FW by a certain delimiter character K using the unnecessary character string processing part 14, the specific character TK may be held or replaced by the delimiter character K as unnecessary character string FW. Since there is a relatively high possibility that a character string, which is helpful to identify an item, such as a music name or an artist name appears before or after a position where a specific character appears, it is possible to accurately perform keyword extraction by holding the specific character TK. In contrast, it is possible to simplify keyword extraction processing by replacing the specific character TK by the delimiter character K.

In a case where item information of an item which is a description object in text data is written by Japanese characters, there is a relatively low possibility that a blank character is included in the item information (e.g., a title, an artist name and the like written by Japanese characters if the item information is music contents). Due to this, if text data is written by Japanese characters, the following processing may be performed: all blank characters are replaced by delimiter characters; or all blank characters are deleted and then character strings before and after a position where each blank character appears are linked with each other.

Returning to FIG. 3, in step S4, the keyword extraction part 15 extracts a keyword. More specifically, the keyword extraction part 15 segments text data into a text region from the beginning S to a character before a position where the first delimiter character K appears by one, one or more text regions each between adjacent delimiter characters K, and a text region from a character after a position where the last delimiter character K appears by one to the end E. Then, the keyword extraction part 15 extracts character strings included in these text regions as respective keywords. In a case where a specific character TK is used, a character string included in a text region between the specific character TK and a delimiter character K, a text region between the specific character TK and the beginning S or a text region between the specific character TK and the end E, may be preferentially extracted as a keyword. By performing this processing, it is possible to further increase accuracy of keyword extraction.

If the processing for replacing an unnecessary character string FW by a blank character using the unnecessary character string processing part 14 has been performed, the keyword extraction part 15 delimits text data at a position where the blank character appears, and then extracts a keyword.

The keyword extraction part 15 may determine whether or not a blank character is included in a keyword with reference to a character type (kanji character, hiragana and katakana phonetic scripts, Roman alphabet, numerical character and the like) in a text region. For example, if a character type of the Roman alphabet mainly appears in a text region, the keyword extraction part 15 extracts a blank character and character strings before and after a position where the blank character appears as one keyword, without linking the character strings before and after the position where the blank character appears with each other. In the example of FIG. 4C, the keyword extraction part 15 extracts “M5: artist (last name), M6: blank and M7: artist (first name)” as one keyword.

In contrast, if character types of kanji character and hiragana and katakana phonetic scripts mainly appear in a text region, the keyword extraction part 15 link character strings before and after a position where a blank character appears with each other, and then extracts the character strings before and after the position where the blank character appears as one keyword. In the example of FIG. 4C, the keyword extraction part 15 extracts “M5: artist (last name) and M7: artist (first name)” as one keyword.

It is preferable that the beginning S and the end E of a keyword do not have blank characters. If a blank character is not included in a keyword, it is preferable that a character string other than the blank character and closest to a specific character is extracted as a keyword.

Alternatively, the keyword extraction part 15 may extract only a character string having a certain length as a keyword. For example, a criterion that a character string is within five to fifteen characters is set, and then the keyword extraction part 15 extracts a keyword with reference to the criterion. In this case, a condition of the length of character string to be extracted as a keyword may be changed according to a character type. For example, in a character string using alphabet, since the length of character string of one word tends to increase, a criterion that the length of character string, which includes non-blank characters and blank characters, is within seven to twenty characters is set.

In a character string including a lot of kanji characters, the length of character string to be extracted as a keyword which is shorter than other character types is set. For example, a criterion that the length of character string is within two to ten characters is set. Further, in a character string using a specific character TK, a condition of the length of character string to be extracted as a keyword may be changed according to a text region adjacent to the specific character TK and a text region away from the specific character TK. For example, a condition of length of character string to be extracted as a keyword is eased in the text region adjacent to the specific character TK (e.g., within three to twenty characters), and a condition of length of character string to be extracted as a keyword is tightened in the text region away from the specific character TK (e.g., within six to twelve characters).

Thus, in step S4, J keywords (J≧1) are extracted from one article text.

In step S5, the grouping processing part 16 creates a keyword group for each article text, using one or more keywords related to each article text extracted in step S4.

If the number of keywords is one (J=1), one keyword group is created. If the number of keywords is two or more (J≧2), plural keywords groups are basically created. Any number of keywords which is one or more, is included in one keyword group.

A method for creating a keyword group will be described below, using four keywords K1, K2, K3 and K4 extracted from text data shown in FIG. 2B, for example.

First, a case of creating a keyword group such that one keyword is included in one keyword group will be described.

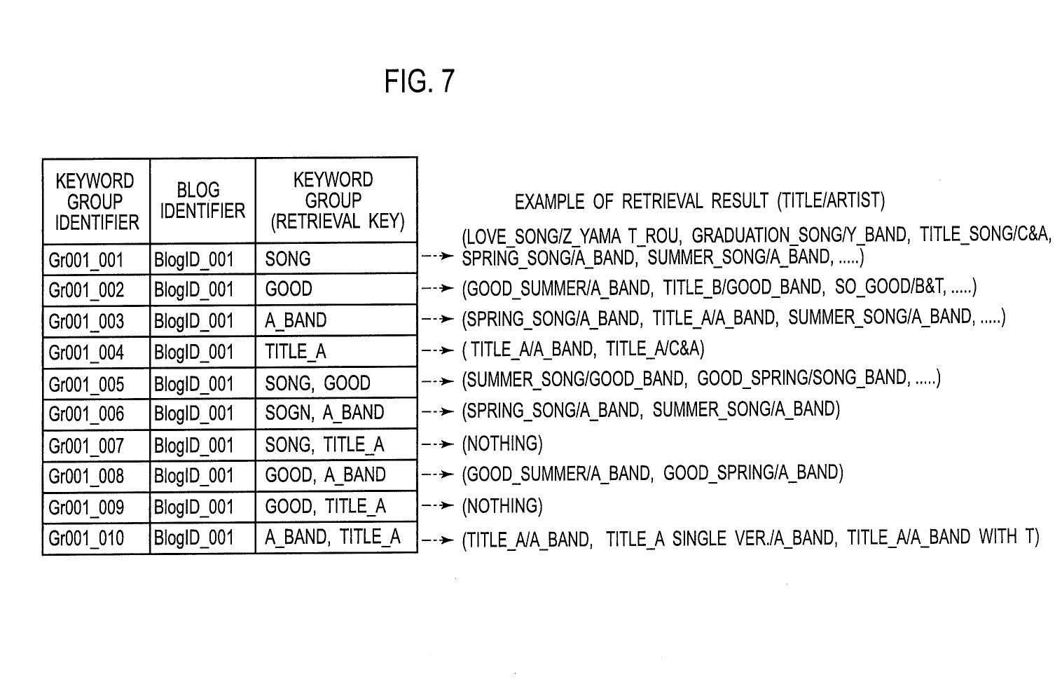

The keyword group in this case is also called a keyword group. The grouping processing part 16 creates a keyword group for each of the keywords K1, K2, K3 and K4. The grouping processing part 16 assigns a keyword group identifier to each created keyword group to identify one keyword group from the other keyword groups, and then stores it in the keyword group storage 5 in the form shown in FIG. 7. FIG. 7 is an example of a retrieval keyword group table based on the text data shown in FIG. 2B.

More specifically, the grouping processing part 16 assigns keyword group identifiers Gr001-001, Gr001-002, Gr001-003 and Gr001-004 to the keywords K1, K2, K3 and K4, respectively. In this example, a character string positioned before a hyphen “-” is determined by a blog identifier. The character string “Gr001” is related to a blog identifier “BlogID_{—}001”. Alternatively, the grouping processing part 16 may assigns keyword group identifiers BlogID_{—}001-001, BlogID_{—}001-002, BlogID_{—}001-003 and BlogID_{—}001-004 to the keywords K1, K2, K3 and K4, respectively, by directly using the blog identifier “BlogID_{—}001” as a character string positioned before a hyphen “-”. A character string positioned after a hyphen “-” is a sequential number. Instead of this, a character string positioned after a hyphen “-” may be a sequential number in order of time when a keyword group is created, or a combination of a time when an article is obtained and a sequential number. The grouping processing part 16 associates the keyword group identifier and the blog identifier with the keyword included in the keyword group, and then stores them in the keyword group storage 5.

Next, a case of creating a keyword group such that two keywords are included in one keyword group will be described.

The grouping processing part 16 create six keyword groups “K1 and K2”, “K1 and K3”, “K1 and K4”, “K2 and K3”, “K2 and K4” and “K3 and K4” which are all permutations of two keywords selected from among four keywords. In the example of FIG. 7, the grouping processing part 16 assigns keyword group identifiers Gr001-005, Gr001-006, Gr001-007, Gr001-008, Gr001-009 and Gr001-010 to “K1 and K2”, “K1 and K3”, “K1 and K4”, “K2 and K3”, “K2 and K4” and “K3 and K4”, respectively.

If there are plural keywords in one keyword group, the plural keywords may be stored as one character string by linking them with each other as one character string using a blank character, or may be stored in the form that each keyword can be read by separating it from the other keywords.

When an item is music, there are many cases where two character strings including a music name and an artist name are helpful to identify an item. Therefore, a keyword group including two keywords allows information which is a description object, to be accurately identified. However, this case increases a processing amount because the number of keyword groups is larger than a case where a keyword group is created such that one keyword group includes one keyword.

If the grouping processing part 16 creates both of a keyword group including the first number of keywords (e.g., one keyword in FIG. 7) and a keyword group including the second number of keywords (e.g., two keywords in FIG. 7) which is larger than the first number of keywords, it is possible to accurately identify information which is a description object without increasing a processing amount, as will be described later. Each keyword group may be assigned to a priority order by adding a column in which a priority order is held in a retrieval keyword group table (not shown in FIG. 7). Then, in step S6, the retrieval part 17 may retrieve the item database 3 according to the priority order. More specifically, the retrieval part 17 performs retrieval using a keyword group having the first priority order, and then performs retrieval using a keyword group having the second priority order.

As a method for assigning a priority order, a degree that keyword criteria (condition) regarding the length of character strings, the type of character or the like is met may be used. It is noted that a keyword extracted from a character string adjacent to a specific character TK may have a higher priority order.

### (Operation of Item Identification Unit 12)

Returning to FIG. 3, in step S6, the retrieval part 17 sequentially reads a keyword group from the keyword group table stored in the keyword group storage 5, creates a retrieval style for each keyword group, and sends a retrieval request to the item database 3.

The item database 3 stores an item table shown in FIG. 6. When receiving a retrieval request, the item database 3 retrieves the item table. If at least one of a character string in a title column and a character string in an artist column satisfies a condition (retrieval style) indicated by the retrieval request, information on the item (e.g., title, artist name and the like) is sent to the text information processing apparatus 1. It is noted that an item identifier may be included in the information to be sent to the text information processing apparatus 1.

Even if a retrieval keyword is not included in item information, it is possible to retrieve and output the item information using a retrieval model such as a vector space model. The retrieval part 17 obtains a list of the item information based on the retrieval style included in the retrieval request.

Data (list of item information) obtained from the item database 3 corresponding to one retrieval style (single retrieval) is called a retrieval result set (retrieval result list). If there is an item which matches a retrieval style, one or more pieces of item information are included in the retrieval result set. It is noted that item information obtained by retrieval is also called a retrieval result.

When plural keywords are specified in a situation where AND or OR condition in a retrieval style is not defined, the item database 3 interprets the retrieval style as meaning that the plural keywords are linked with each other using AND condition. If there are plural items which match a retrieval style, the item database 3 may send a retrieval result with a priority order. For example, an order of the retrieval result is determined such that an item having the first priority order is defined as the first retrieval result, and an item having the second priority order is defined as the second retrieval result, and so on.

A priority order may be calculated using a degree of similarity between a retrieval style and item information, or using a degree of popularity of an item. For example, the number of times that an item is output as a retrieval result is counted for each item, and the counted number of times is defined as a degree of popularity of the item. Then, an item having a high degree of popularity is defined as a high priority order. Alternatively, a degree of popularity may be calculated using information on the number of use times of an item, a sales amount of an item or the like which can be obtained from the outside. The text information processing apparatus 1 may calculate a degree of popularity based on ranking information which will be described later, for each item, and periodically send this information to the item database 3. Then, the item database 3 may determine a priority order using this information. Although the retrieval processing is performed while the retrieval part 17 and the item database 3 work in collaboration in the present embodiment, either of the retrieval part 17 or the item database 3 may perform the retrieval processing alone.

The retrieval part 17 uses one keyword group for a single retrieval. If a keyword group includes plural keywords, the retrieval part 17 creates a retrieval style using the plural keywords which are linked with each other using AND condition. A set of keywords used in one retrieval style is called a retrieval key. In the present embodiment, a keyword group corresponds to a retrieval key. When AND or OR condition is not included in a retrieval style and the retrieval style is composed of one or more keywords, a retrieval style is equivalent to a retrieval key.

For example, when the retrieval part 17 performs retrieval using a keyword group in which only one keyword is included, item information (title and artist name in the present embodiment) which has the keyword in at least one of the title column and the artist column of the item table, is output.

As shown in FIG. 7, when the retrieval part 17 performs retrieval using a keyword group in which only one keyword “song” with the keyword group identifier Gr001-001 is included, a retrieval result which has the keyword “song” in at least one of the title column and the artist column of the item table, is output. For example, a list of titles and artist names such as “Love_Song/Z_Yama T_Rou”, “Graduation_Song/Y_Band”, “Title_Song/C&A”, “Spring_Song/A_Band” and “Summer_Song/A_Band” are output as a retrieval result.

When two keywords (K1, K2) are included in a keyword group, a retrieval style (K1 AND K2) is created. Thereby, information representing an item in which a keyword K1 is included in at least one of the title column and the artist column and a keyword K2 is included in at least one of the title column and the artist column, is output.

As shown in FIG. 7, when the retrieval part 17 performs retrieval using a keyword group in which two keywords “Song” and “A_Band” with the keyword group identifier Gr001-006 are included, a retrieval result which has the keyword “Song” in at least one of the title column and the artist column of the item table and has the keyword “A_Band” in at least one of the title column and the artist column of the item table, is output. For example, a list of titles and artist names such as “Spring_Song/A_Band” and “Summer_Song/A_Band”, are output as a retrieval result.

In step S7, the item identification unit 12 performs normalization of each piece of item information included in a retrieval result set. This normalization is performed to deal with a problem that the item database 3 returns substantially the same items as different retrieval results. When an item is music, there is a case that some patterns in a representation of a music name are substantially used in the same music.

For example, regarding one music “Title_A/Artist_B”, the item database 3 returns retrieval results such as “Title_A (version C)/Artist_B”, “Title_A/Artist_B (featuring X)” and “Title_A/Artist_B with X”. Especially, in a case where the item table is created based on music information created and provided by many users, the problem tends to occur. By performing the normalization of item information, it is possible to integrate the above-described variations of representation of music name into one. More specifically, with respect to a character string of each piece of item information (title and artist name in the present embodiment) included in a retrieval result set, a normalized character string is created by removing a predetermined character string and converting a character type. For example, a character string enclosed in parentheses “(” and “)” may be removed.

In addition, a character string such as “featuring” or “with” heavily used to supplement an artist name may previously be registered, and then one or more character strings after a position where the character string appears may be removed from an artist name in a retrieval result. Processing for converting a character type may be performed. For example, one-byte katakana phonetic script, two-bytes alphabet and two-bytes numerical character are respectively converted into two-bytes katakana phonetic script, one-byte alphabet and one-byte numerical character. Although the normalization processing is not necessarily performed, text data is further accurately related to an item by performing the normalization processing for the retrieval result.

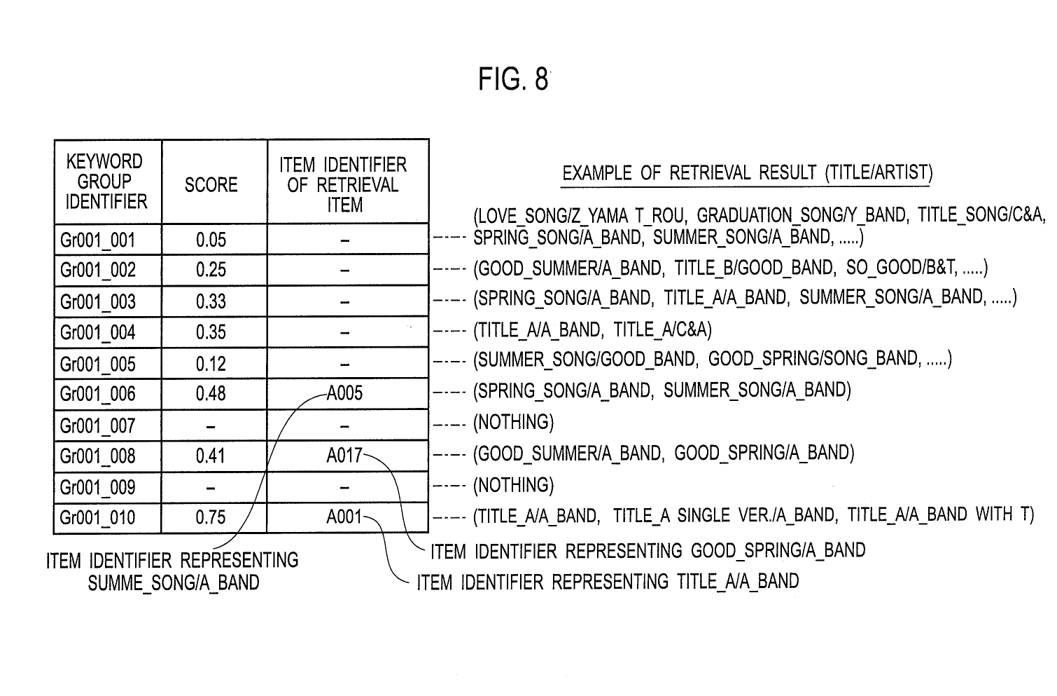

In step S8, the item identification unit 12 performs a degree-of-similarity calculation between respective two pieces of item information included in the retrieval result set using each pieces of the normalized item information created in step S7, and calculates an average value of the calculated result as a score. Then, the item identification unit 12 associates the calculated score with the keyword group identifier, and stores it in a score column of a retrieval result score table shown in FIG. 8. As the result of retrieval, when a proper item is not found (the retrieval result set is an empty set), a score of the corresponding keyword group is not stored.

Next, a score calculation method will be described below. For example, when three pieces of item information “Spring_Song/A_Band”, “Title_A/A_Band” and “Summer_Song/A_Band” are output, a degree of similarity between “Spring_Song/A_Band” and “Title_A/A_Band”, a degree of similarity between “Spring_Song/A_Band” and “Summer_Song/A_Band”, a degree of similarity between “Title_A/A_Band” and “Summer_Song/A_Band” are calculated. Then, an average value of three pieces of degree of similarity is calculated as a score. Thus, when a degree of similarity is calculated for each of all combinations of item information included in the retrieval result set, a score is accurately calculated, but a processing amount increases.

Alternatively, the item identification unit 12 may select one reference item (reference retrieval result) from among items in the retrieval result set, calculate a degree of similarity between the reference item and each item other than the reference item in the retrieval result set, and calculate an average value of them as a score. For example, when “Spring_Song/A_Band” is selected as a reference item, a degree of similarity between “Spring_Song/A_Band” and “Title_A/A_Band” and a degree of similarity between “Spring_Song/A_Band” and “Summer_Song/A_Band” are calculated. Then, an average value of two pieces of degree of similarity is calculated as a score. In this case, the accuracy of score is reduced, but a processing amount decreases, in comparison with the case where a degree of similarity is calculated for each of all combinations of item information included in the retrieval result set. In view of this, when much item information is included in a retrieval result set, it is desirable to calculate a score using a reference item.

When only two pieces of item information are included in the retrieval result set, a degree of similarity between the two pieces of item information is used as a score. When only one piece of item information is included in the retrieval result set, the item information of the retrieval result set is associated with a blog identifier without calculating a degree of similarity and a score.

In the calculation of degree of similarity, various methods can be used. For example, morphological analysis processing is performed to extract words with respect to N normalized retrieval results (N≧2). At this time, a specific word class such as noun or adjective may be set as an object to be extracted, or postpositional particles and auxiliary verbs in Japanese words may be removed. When M words are extracted, N×M occurrence matrix is created by arranging the N retrieval results (N pieces of item information) and the M words in an array of rows and columns in the matrix, respectively. The N×M occurrence matrix has the frequency (number of times) of appearance of a word in a retrieval result as a matrix element. Instead of using the frequency of appearance as a matrix element, the matrix element may have a value “1” when a word appears in a retrieval result and a value “0” when a word does not appear in a retrieval result. An element in the N×M occurrence matrix is represented by dᵢⱼ (i=1 to N, j=1 to M) below. The symbol “i” represents i-th row, and the symbol “j” represents j-th column.

Here, a degree of similarity may be calculated for each of all combinations of the N normalized retrieval results. However, in order to simplify the processing, one row is selected as a reference retrieval result (reference item) from among N rows in the N×M occurrence matrix, and then a degree of similarity between the reference retrieval result and each retrieval result other than the reference retrieval result is calculated. Although the reference retrieval result may be randomly selected using a random number, a retrieval result on the first row is set as the reference retrieval result (item information which the item database 3 firstly outputs) in the present embodiment.

In the present embodiment, as shown in Eq. 1, a cosine degree of similarity is used in the calculation of degree of similarity. When a retrieval result on K-th row is set as the reference retrieval result, a degree of similarity Sᵢₖ between the reference retrieval result and i-th retrieval result (retrieval result on i-th row) is calculated using an equation shown in Eq. 1. It is noted that i=1 to N, i≠k, and j=1 to M.

$${S}_{ik} = \frac{{\sum }_{j = 1}^{M} {d}_{ij} \times {d}_{kj}}{\sqrt{{\sum }_{j = 1}^{M} {d}_{ij}^{2}} \sqrt{{\sum }_{j = 1}^{M} {d}_{kj}^{2}}} \qquad Eq . 1$$

Although a cosine degree of similarity is used in the present embodiment, an equation for calculation of degree of similarity is not limited to it. For example, a degree of similarity may be calculated using a conventional Jaccard coefficient, Simpson coefficient, Pearson product-moment correlation coefficient or the like. Also, a degree of similarity may be calculated by comparing retrieval results with each other by a character unit without extracting words using a morpheme analysis. For example, a degree of similarity may be calculated by determining whether or not the p-th character from the beginning of character string in one normalized retrieval result matches the p-th character from the beginning of character string in the other normalized retrieval result. Also, a measure such as Levenshtein distance which is used as a degree of similarity of character string in general, may be calculated.

Then, an average value of plural pieces of degree of similarity obtained by one retrieval result set is calculated as a score. For example, when N (N≧3) retrieval results are obtained, (N−1) pieces of degree of similarity each between the reference retrieval result and another retrieval result are calculated. Then, an average value of the (N−1) pieces of degree of similarity is calculated. Although an average value of plural pieces of degree of similarity is calculated as a score, a minimum value, a median value, a mode value, a quartile value or the like of degree of similarity may be calculated as a score. The plural pieces of degree of similarity regarding the N retrieval results become larger as the score is larger. Alternately, the following calculation may be used to obtain a score. First, the number of pieces of degree of similarity each of which is equal to or more than a predetermined value is counted from among plural pieces of degree of similarity calculated from one retrieval result set. Then, a value obtained by dividing the counted number of pieces of degree of similarity by the number of items N included in the one retrieval result set or the number of plural pieces of degree of similarity calculated from the one retrieval result set, is set as a score.

Since there are many cases where a general word used in a blog article matches a word used in a music title, it is difficult to distinguish the general word used in a blog article from the word used in a music title according to a rule which has been previously made. Thus, there is a case where a general word which is not related to an item is included in an extracted keyword.

In a case where a keyword is a general word, if the item database 3 is retrieved using the keyword, there is a high possibility that a retrieval result regarding not one piece of music, but instead plural pieces of music is returned. For example, since there are many pieces of music whose each of music titles includes the general word “love” therein, if the item database 3 is retrieved using the general word “love” as a retrieval key, there is a high possibility that a retrieval result regarding plural pieces of music is obtained. In this case, since various retrieval results are obtained, a degree of similarity between retrieval results becomes low, thereby a score has a low value.

On the other hand, in a case where a keyword is a word which is specific to one piece of music or whose a general use frequency is low, there is a high possibility that even if plural retrieval results are obtained, they substantially relate to one piece of music. In this case, a degree of similarity between retrieval results becomes high, thereby a score has a large value. Thus, by calculating a score in the above-described method, it is possible to surely determine whether or not one item is identified by a keyword (keyword group) used in retrieval.

Next, in step S9, the determination part 19 of the item identification unit 12 determines that a score is equal to or more than the threshold θ. The value of θ may be set using a retrieval result previously obtained on a trial basis, or may be changed depending on the situation. If the score is equal to or more than the threshold θ, the determination part 19 determines that it is a keyword group associated with item identification, and proceeds to step S10. In step S10, the determination part 19 returns a true, and selects a candidate item which is a candidate for an item corresponding to a blog article in a retrieval result set, and then stores an item identifier of the candidate item in a column of “item identification of candidate item” of the retrieval result score table shown in FIG. 8. If the score is less than the threshold θ, the determination part 19 determines that it is not a keyword group associated with item identification, and proceeds to step S11. In step S11, the determination part 19 returns a false.

FIG. 8 illustrates the retrieval result score table which includes scores of keyword groups with keyword group identifies Gr001-001 to Gr001-010. The retrieval result score table is stored in the score storage 7.

If the threshold θ is 0.4, three keyword groups Gr001-006, Gr001-008 and Gr001-010 have scores more than the threshold θ in the example of FIG. 8. A keyword group having a score equal to or more than the threshold θ is associated with one item identifier in a retrieval result set. It is noted that the threshold θ may be changed according to the number of keywords included in the keyword group. In this case, a threshold becomes larger (in the threshold, it is difficult to be true) as the number of keywords is larger. As a method for selecting one item (candidate item) in a retrieval result set, the following methods can be used.

The first method is a method for selecting a first item (item which the retrieval part 17 first obtains) to be output as a retrieval result by the item database 3. This method can be used when the item database 3 outputs a retrieval result to which a priority order is assigned. The text information processing apparatus 1 stores information on an order of the obtained retrieval result therein.

The second method is a method for calculating a degree of similarity between a keyword group (retrieval key) and each of retrieval results based on the keyword group, and then selecting a retrieval result (item) which has the highest degree of similarity. For example, regarding the keyword group Gr001-010 including “Title_A” and “A_Band” therein, a degree of similarity between the keyword “Title_A” and “A_Band” and each of retrieval results “Title_A/A_Band”, “Title_A single ver./A_Band” and “Title_A/A_Band with T” is calculated. The degree of similarity may be calculated in a manner of comparing two character strings by one character. In this case, since the retrieval result “Title_A/A_Band” has the highest degree of similarity, the determination part 19 determines the retrieval result “Title_A/A_Band” as a candidate item, identifies A001 which is an item identifier of “Title_A/A_Band” while referring to the item table of FIG. 6, and stores it as a candidate item identifier corresponding to the keyword group Gr001-010 in the retrieval result score table. It is noted that a difference (degree of difference) or a distance between a keyword group and each of retrieval results may be calculated, instead of a degree of similarity.

The third method is a method for selecting an item which has the smallest difference between item information normalized in step S7 and item information before the normalization. For example, when the item database 3 outputs three items (1) “Title_A/A_Band”, (2) “Title_A single ver./A_Band” and (3) “Title_A/A_Band with T” and all results obtained by normalizing them have “Title_A/A_Band”, (1) “Title_A/A_Band” in which a character string does not change before and after the normalization is selected.

The fourth method is a method for selecting an item which has the highest ranking in ranking information, using the ranking information having been created which will be described later. This method uses a tendency that there is a high possibility that an item which frequently appeared in past blog articles, appears in a new blog article.

Next, in step S12, the determination part 19 determines that validity determination of all keyword groups has been finished. If the validity determination has not been finished, it returns to step S9 and then the determination part 19 compares a score in a next keyword group with the threshold. If the validity determination has been finished, it proceeds to step S13. It is noted that it may proceed to step S13 when there is one keyword group for which a result of validity determination is true, without determining that validity determination of all keyword groups has been finished. This reduces calculation load.

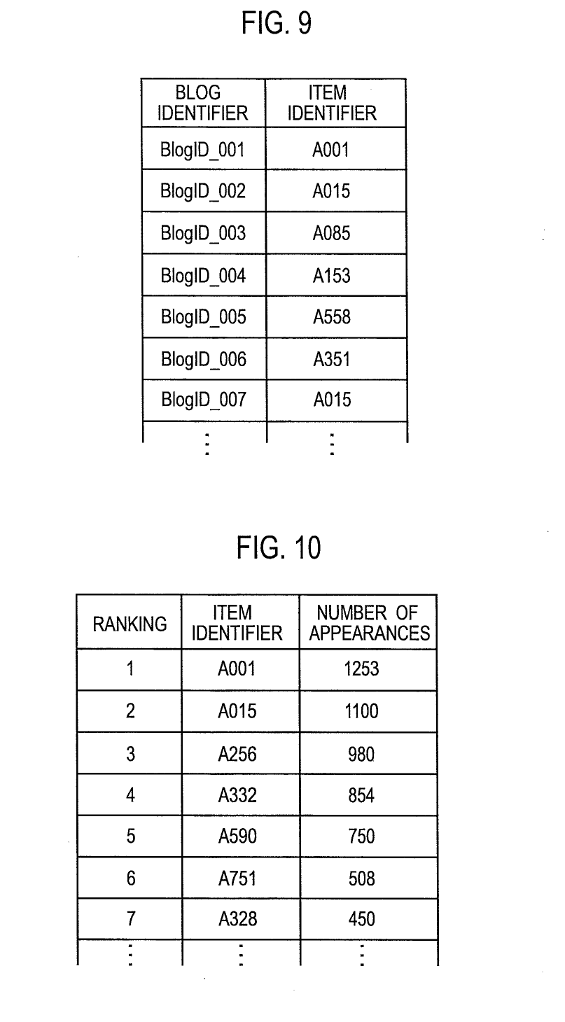

In step S13, the determination part 19 stores an item identifier and a blog identifier for which a result of validity determination is true, in an item calculation result table of FIG. 9 in the item calculation result storage 8. Thus, the determination part 19 identifies that the item identifier for which a result of validity determination is true is item information corresponding to the blog identifier.

In the example of FIG. 8, there are plural keyword groups (three keyword groups) which have scores more than the threshold, and item identifiers (candidate item identifiers) are respectively associated with the plural keyword groups. An item identifier of which a keyword group has the highest score may be stored in the item calculation result table from among the item identifiers, or all item identifiers of which the plural keyword groups have scores more than the threshold may be stored in the item calculation result table. This is due to a possibility that plural items are described in one piece of text data. If accuracy for identifying an item is required, it is desirable that only the item identifier of which the keyword group has the highest score is stored in the item calculation result table. Alternately, plural item identifiers corresponding to plural keyword groups selected in descending order of scores may be stored in the item calculation result table. Also, after a candidate item is stored in the retrieval result score table even if a score calculated in step S8 is less than the threshold, an item identifier of a candidate item corresponding to a keyword group which has the highest score, may be stored in the item calculation result table.

When an item identifier of which a keyword group has the highest score is stored, a blog identifier BlogID_{—}001 and an item identifier A001 are output to the item calculation result table in the example of FIGS. 7 and 8.

As described above, an item identifier which is the description object can be related to a blog identifier with accuracy. Although one candidate item is selected in one retrieval result set and then stored in the retrieval result score table, plural candidate items may be selected in one retrieval result set and then stored in the retrieval result score table.

The text information processing apparatus 1 may include a display control unit 21 which displays on a display, information on the identified item together with a corresponding blog article or information on the blog article (e.g., blog identifier or title of blog). For example, the display of an item name and a blog article allows a user to instantly identify that an item is word-of-mouth information. It is noted that the display (not shown) may be included in the text information processing apparatus 1 or the terminal device 4.

If an item name and plural blog articles associated with the item are displayed on the same screen, a user can plural pieces of word-of-mouth information related to the item at once, which is useful.

### (Operation of Ranking Information Creation Unit 13)

Returned to FIG. 3, processing to be carried out by the ranking information creation unit 13 will be described below. In step S14, the ranking information creation unit 13 extracts item information (title, artist and the like), a user identifier and an article creation update date which correspond to a combination of a blog identifier and an item identifier stored in the item calculation result table, with reference to the item calculation result table of FIG. 9, the text data table of FIG. 5 and the item table of FIG. 6.

In step S15, the ranking information creation unit 13 counts the number of appearances of each item identifier in the item calculation result table, creates a list (first list) of combination of an item identifier and the number of appearances, wherein the list has item identifiers sorted in descending order of the number of appearances, and stores it in the item ranking information storage 9. It is noted that when one user writes a blog article about an item a prescribed number of times more than, the number of appearances of the item may be decreased according to a predetermined rule.

In step S16, the ranking information creation unit 13 counts the number of different types of user identifiers (the number of appearances of different user identifiers) with respect to each item identifier stored in the item calculation result table using data created in step S14. Namely, the ranking information creation unit 13 counts the number of users each who describes an item in his/her blog. Then, the ranking information creation unit 13 creates a list (second list) of combination of an item identifier and the number of different types of user identifiers, wherein the list has item identifiers sorted in descending order of the number of appearances, and stores it in the item ranking information storage 9.

In step S17, the ranking information creation unit 13 creates a ranking table in the form of FIG. 10 using the first list created in step S15 and the second list created in step S16. The ranking table is stored in the ranking information storage 9. The ranking table is a table in which a ranking, an item identifier, and the number of appearances of each item identifier are associated with one another. The ranking table is created using various methods.

More specifically, the ranking information creation unit 13 ranks items in descending order of the number of appearances of each item based on the first list. If there are items which have the same number of appearances, the ranking information creation unit 13 ranks the items in descending order of the number of different types of user identifiers based on the second list. Namely, under a condition where the number of appearances of each item identifier is set as a first priority item and the number of different types of item identifiers is set as a second priority item, items are sorted in descending order and then ranked. Alternately, the items may be sorted in descending order and then ranked under a condition where the number of different types of item identifies is set as a first priority item and the number of appearances of each item identifier is set as a second priority item.

The above-described ranking table creation method is one example, and various methods may be used for the creation of ranking. For example, the ranking information creation unit 13 calculates a total score of each item identifier based on the first list and the second list, and then ranks items in descending order of total scores. The total scores may be stored in the ranking table. Also, the ranking information creation unit 13 may perform statistical processing based on various numerical values related to each identified item. For example, the ranking information creation unit 13 sets plural counting periods, compares the number of appearances of one item for one counting period with the number of appearances of another item for another counting period, calculates an increase-decrease rate of the number of appearances and the like, and assigns information such as “sudden change” to an item which has a high increase-decrease rate.

The display control unit 21 may display on the display, the ranking and the like created as described above. Also, the display control unit 21 may display on the display, ranking, a blog article associated with items included in the ranking, and information on a user who writes the blog article. The display is a display (not shown) included in the text information processing apparatus 1 or the terminal device 4.

As described above, the text information processing apparatus 1 according to the present embodiment can accurately extract an item which is a product or a service, from text data such as blog.

The text information processing apparatus 1 according to the present embodiment can perform statistical processing with respect to the extracted item information. For example, the text information processing apparatus 1 extracts plural pieces of music which are description objects in a micro log service or the like within a predetermined period (e.g., one week, one day or one hour), counts the number of articles or users by each piece of music, ranks the plural pieces of music based on the count number, and thereby the extracted item information can be applied to marketing and used as statistical data of market trend. Further, if this information is provided to users, it is expected that buying motivation of the users increases.

### Second Embodiment

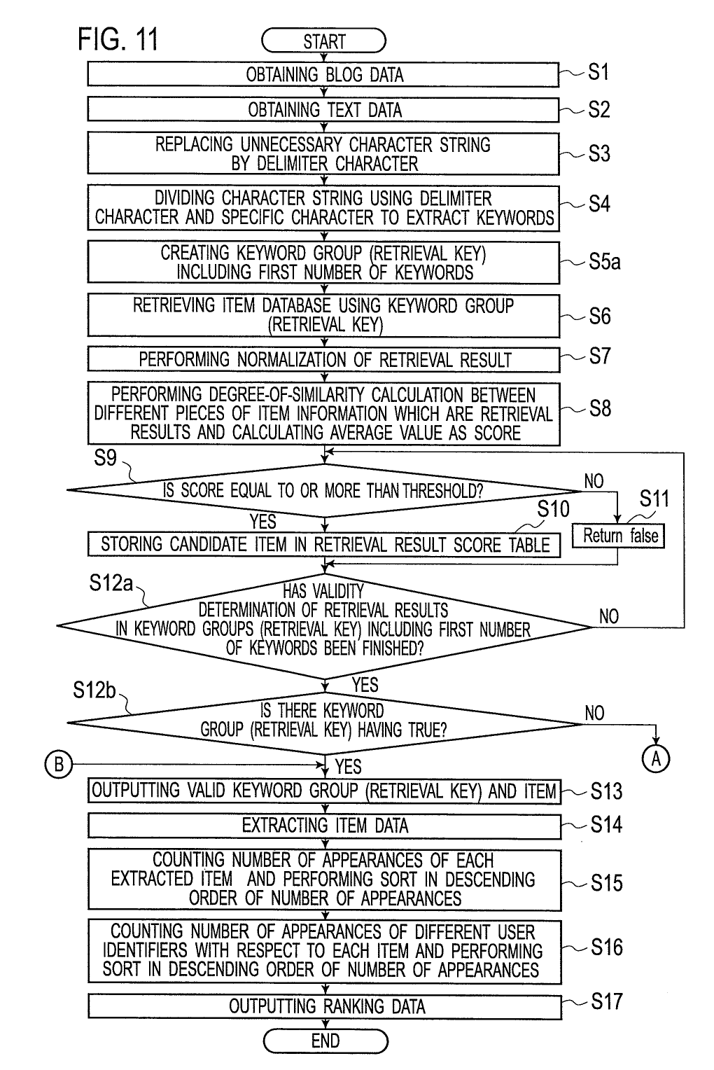

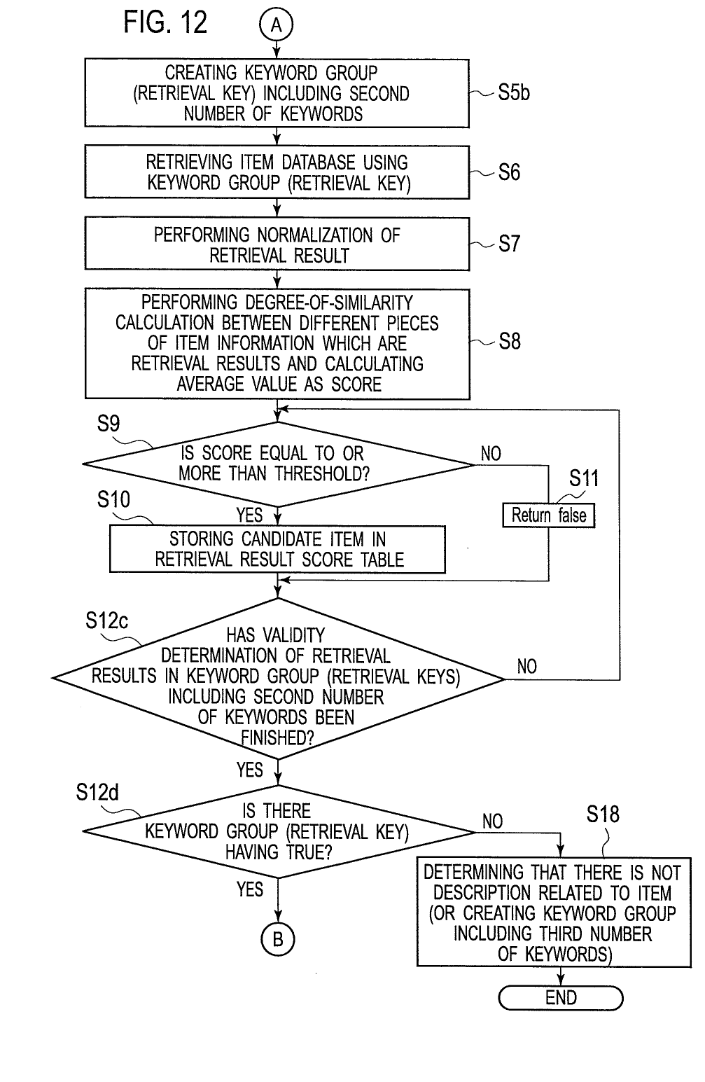

Next, a second embodiment of the present invention will be described with reference to FIGS. 11 and 12.

In the first embodiment, both/either retrieval using a keyword group including keywords of which the number is a first number and/or retrieval using a keyword group including keywords of which the number is a second number larger than the first number is carried out. In contrast, in the present embodiment, the number of keywords included in a keyword group is increased according to a determination as to whether or not an item is identified. This allows information which is a description object, to be accurately identified while reducing a processing amount.

Steps other than steps S5a, S12a and S12b in FIG. 11 and steps S5b, S12c and S12d in FIG. 12 are similar to the steps other than S5 and S12 in FIG. 3 in the first embodiment. The description of the steps other than S5a and S12a to S12d is omitted.

In the present embodiment, in step S5a, the grouping processing part 16 creates keyword groups each including keywords of which the number is the first number for each article text. For example, the grouping processing part 16 creates keyword groups such as the keyword groups shown in FIG. 7 to which the keyword group identifiers Gr001-001 to Gr001-004 are assigned, each of which includes one keyword therein.

In steps S6 to S11, validity determination of all keyword groups is carried out as well as the first embodiment. In step S12a, the determination part 19 determines whether or not the validity determination of all keyword groups, each of which includes the first number of keywords therein, has been finished. If the validity determination has not been finished, it returns to step S9 and then the determination part 19 compares a score in a next keyword group with the threshold. If the validity determination has been finished, it proceeds to step S12b.

In step S12b, the determination part 19 determines whether or not there is a keyword group having a true. If there is a keyword group having a true, it proceeds to step S13 and the determination part 19 outputs the keyword group having a true and an item. If there is not a keyword group having a true, it proceeds to step S5b in FIG. 12.

In step S5b, the grouping processing part 16 creates keyword groups each including keywords of which the number is the second number larger than the first number, for each article text. For example, the grouping processing part 16 creates keyword groups such as the keyword groups shown in FIG. 7 to which the keyword group identifiers Gr001-005 to Gr001-010 are assigned, each of which includes two keywords therein. Since a system load in the processing of creating keyword groups is smaller than one in the retrieval processing, the keyword groups each of which includes the second number of keywords may be previously created.

In the following steps S6 to S11, validity determination of all keyword groups is carried out as well as the first embodiment. In step S12c, the determination part 19 determines whether or not the validity determination of all keyword groups, each of which includes the second number of keywords therein, has been finished. If the validity determination has not been finished, it returns to step S9 and then the determination part 19 compares a score in a next keyword group with the threshold. If the validity determination has been finished, it proceeds to step S12d.

In step S12d, the determination part 19 determines whether or not there is a keyword group having a true. If there is a keyword group having a true, it proceeds to step S13 in FIG. 11 and the determination part 19 outputs the keyword group having a true and an item. If there is not a keyword group having a true, it proceeds to step S18. In step S18, the determination part 19 determines that an item is not described in the article text.

Alternately, without finishing the processing, the grouping processing 16 may create keyword groups each including keywords of which the number is the third number larger than the second number, for each article text. Then, the similar processing is continued. The number of keywords to be included in a keyword group is arbitrarily determined according to the kind of item to be identified.

As described above, the retrieval is carried out by increasing the number of keywords included in a keyword group according to a determination as to whether or not an item is identified. This allows information which is a description object, to be accurately identified while reducing a processing amount.

The present invention is not limited to the above-described embodiments. The present invention may be applied to a text other than a blog such as questionnaire data. Although the processing is illustrated using a blog article related to music in the above-described embodiments, the processing can be performed using an article related to a topic other than music.

The present invention includes a program for causing a computer to realize a function of each element. The program may be loaded in the computer from a recording medium or through a communication network.

It will be obvious to those skilled in the art that various changes may be made without departing from the scope of the invention. For example, a modification may be introduced into each embodiment. A part of the text information processing apparatus 1, which is separated from the other parts of the text information processing apparatus 1, may be connected to the other parts through a network or the like.

What is claimed is:

1. A text information processing apparatus comprising:
a retrieval part configured to obtain a retrieval result set which includes one or plural pieces of item information and corresponds to a retrieval key extracted from text data, from item database which stores item information therein;
a degree-of-similarity calculation part configured to calculate a score of the retrieval result set, based on one or more pieces of degree of similarity each between different pieces of item information in the plural pieces of item information; and
a determination part configured to identify item information corresponding to the text data from among the plural pieces of item information, based on the score.

2. The text information processing apparatus according to claim 1, wherein the retrieval part obtains plural retrieval result sets respectively corresponding to plural retrieval key extracted from the text data.

3. The text information processing apparatus according to claim 2, wherein the determination part identifies item information included in a retrieval result set which has the highest score in the plural retrieval result sets, as item information corresponding to the text data.

4. The text information processing apparatus according to claim 2, wherein the determination part identifies item information included in a retrieval result set which has a score equal to or more than a threshold in the plural retrieval result sets, as item information corresponding to the text data.

5. The text information processing apparatus according to claim 2, wherein the plural retrieval key includes a retrieval key composed of a set which includes an arbitrary number of keywords selected from among plural keywords extracted from the text data.

6. The text information processing apparatus according to claim 1, wherein when the retrieval part obtains a retrieval result set which includes three or more pieces of item information and corresponds to the retrieval key, the degree-of-similarity calculation part calculates plural pieces of degree of similarity each between different pieces of item information in the three or more pieces of item information, and defines as the score, an average value, a median value, a mode value, a quartile value, a minimum value or a maximum value of the plural pieces of degree of similarity.

7. The text information processing apparatus according to claim 1, wherein when the retrieval part obtains a retrieval result set which includes three or more pieces of item information and corresponds to the retrieval key, the degree-of-similarity calculation part calculates plural pieces of degree of similarity each between different pieces of item information in the three or more pieces of item information, and defines as the score, a value obtained by dividing the number of pieces of degree of similarity each of which has a value equal to or more than a certain value in the plural pieces of degree of similarity, by the number of three or more pieces of item information included in the retrieval result set.

8. The text information processing apparatus according to claim 1, wherein when the retrieval part obtains a retrieval result set which includes three or more pieces of item information and corresponds to the retrieval key, the degree-of-similarity calculation part calculates plural pieces of degree of similarity each between different pieces of item information in the three or more pieces of item information, and defines as the score, a value obtained by dividing the number of pieces of degree of similarity each of which has a value equal to or more than a certain value in the plural pieces of degree of similarity, by the number of the plural pieces of degree of similarity.

9. The text information processing apparatus according to claim 1, when the determination part does not identify item information using a retrieval result set corresponding to a retrieval key composed of a set of keywords, of which the number is a first number, selected from plural keywords extracted the text data, the determination part identifies item information corresponding to the text data using a retrieval result set corresponding to a retrieval key composed of a set of keywords of which the number is a second number larger than the first number.

10. The text information processing apparatus according to claim 1, further comprising a display control part configured to display the text data and item information corresponding to the text data on a display.

11. The text information processing apparatus according to claim 1, further comprising a ranking information creation part configured to create ranking information based on the item information identified by the determination part.

12. The text information processing apparatus according to claim 1, further comprising a retrieval key generation part configured to generate a second text data by replacing a first character string included in the text data by a second character string, and generate a retrieval key using the second text data.

13. The text information processing apparatus according to claim 1, wherein when the score meets a certain condition, the determination part identifies item information corresponding to the text data from among the plural pieces of item information, based on an order to obtain the plural pieces of item information or a difference between the retrieval key and each of the plural pieces of item information.

14. A text information processing method comprising:
obtaining a retrieval result set which includes one or plural pieces of item information and corresponds to a retrieval key extracted from text data, from item database which stores item information therein;
calculating a score of the retrieval result set, based on one or more pieces of degree of similarity each between different pieces of item information in the plural pieces of item information; and
identifying item information corresponding to the text data from among the plural pieces of item information, based on the score.

15. A non-transitory computer usable medium having text information processing program embodied therein, the text information processing program comprising:
a first text information processing program code for causing a computer to obtain a retrieval result set which includes one or plural pieces of item information and corresponds to a retrieval key extracted from text data, from item database which stores item information therein;
a second text information processing program code for causing the computer to calculate a score of the retrieval result set, based on one or more pieces of degree of similarity each between different pieces of item information in the plural pieces of item information; and
a third text information processing program code for causing the computer to identify item information corresponding to the text data from among the plural pieces of item information, based on the score.
